(19) United States
(12) Patent Application Publication
(10) Pub. No.: US 2018/0307753 A1
(43) Pub. Date: Oct. 25, 2018

(54) ACOUSTIC EVENT ENABLED GEOGRAPHIC MAPPING

(71) Applicant: QUALCOMM Incorporated, San Diego, CA (US)

(72) Inventors: Yinyi GUO, San Diego, CA (US); Erik Visser, San Diego, CA (US); Lae-Hoon Kim, San Diego, CA (US)

(21) Appl. No.: 15/494,379

(22) Filed: Apr. 21, 2017

(51) Int. Cl. G06F 17/30; G10L 25/51

(52) U.S. Cl. CPC G06F 17/30778; G06F 17/30241; H04R 1/406; G10L 25/51; G06F 17/30752

(57) ABSTRACT

An electronic device includes a classifier circuit, a ranking circuit, and a data generator circuit. The classifier circuit is configured to determine, based on first data indicating samples of sounds detected at a plurality of geographic locations, a plurality of acoustic event classifications associated with the plurality of geographic locations. The ranking circuit is configured to determine a plurality of index scores associated with the plurality of geographic locations by ranking each of the plurality of geographic locations based on the plurality of acoustic event classifications. The data generator circuit is configured to generate, based on the plurality of index scores, second data indicating a geographic map corresponding to the plurality of geographic locations. The second data further indicates the plurality of index scores and a prompt to enable a search for a particular type of acoustic event.

### I. FIELD

This disclosure is generally related to electronic devices and more particularly to electronic devices that use or display geographic maps.

### II. DESCRIPTION OF RELATED ART

Advances in technology have resulted in smaller and more powerful computing devices. For example, personal computing devices include wireless telephones (e.g., mobile and smart phones), tablets, and laptop computers that are small, lightweight, and easily carried by users. These devices can communicate voice and data packets over wired networks, wireless networks, or both. Further, many such devices incorporate additional functionality such as a digital still camera, a digital video camera, a digital recorder, and an audio file player. Such devices can also process executable instructions, including software applications, such as a web browser application, that can be used to access the Internet. As such, these devices can include significant computing capabilities.

Such a device may use information about its current environment or context to adjust settings or offer services to a user. For example, in some contexts, the volume of sound output by the device may be adjusted. The device may use information indicating a sound environment to determine the environment or context in which the device is situated. However, identifying or classifying a context of the device based on the sound environment can be unreliable and can use significant processing resources.

### III SUMMARY

In an illustrative example, an electronic device includes a classifier circuit, a ranking circuit, and a data generator circuit. The classifier circuit is configured to determine, based on first data indicating samples of sounds detected at a plurality of geographic locations, a plurality of acoustic event classifications associated with the plurality of geographic locations. The ranking circuit is configured to determine a plurality of index scores associated with the plurality of geographic locations by ranking each of the plurality of geographic locations based on the plurality of acoustic event classifications. The data generator circuit is configured to generate, based on the plurality of index scores, second data indicating a geographic map corresponding to the plurality of geographic locations. The second data further indicates the plurality of index scores and a prompt to enable a search for a particular type of acoustic event.

In another example, a method includes determining, based on first data indicating samples of sounds detected at a plurality of geographic locations, a plurality of acoustic event classifications associated with the plurality of geographic locations. The method further includes determining a plurality of index scores associated with the plurality of geographic locations by ranking each of the plurality of geographic locations based on the plurality of acoustic event classifications. The method further includes generating, based on the plurality of index scores, second data indicating a geographic map corresponding to the plurality of geographic locations. The second data further indicates the plurality of index scores and a prompt to enable a search for a particular type of acoustic event.

In another example, an apparatus includes means for determining, based on first data indicating samples of sounds detected at a plurality of geographic locations, a plurality of acoustic event classifications associated with the plurality of geographic locations. The apparatus further includes means for ranking each of the plurality of geographic locations based on the plurality of acoustic event classifications to determine a plurality of index scores associated with the plurality of geographic locations. The apparatus further includes means for generating, based on the plurality of index scores, second data indicating a geographic map corresponding to the plurality of geographic locations. The second data further indicates the plurality of index scores and a prompt to enable a search for a particular type of acoustic event.

In another example, a computer-readable medium stores instructions executable by a processor to perform operations. The operations include determining, based on first data indicating samples of sounds detected at a plurality of geographic locations, a plurality of acoustic event classifications associated with the plurality of geographic locations. The operations further include determining a plurality of index scores associated with the plurality of geographic locations by ranking each of the plurality of geographic locations based on the plurality of acoustic event classifications. The operations further include generating, based on the plurality of index scores, second data indicating a geographic map corresponding to the plurality of geographic locations. The second data further indicates the plurality of index scores and a prompt to enable a search for a particular type of acoustic event.

### IV. BRIEF DESCRIPTION OF THE DRAWINGS

FIG. 1 is a diagram of an illustrative example of an electronic device configured to perform acoustic event enabled geographic mapping operations and a graphical user interface that may be presented by the electronic device or by another device.

FIG. 2 is a diagram of an illustrative example of a set of operations that may be performed by the electronic device of FIG. 1.

FIG. 3 is a diagram of an illustrative example of a system that includes the electronic device of FIG. 1.

FIG. 4 is a diagram illustrating an example of a data augmentation process that may be performed by the electronic device of FIG. 1.

FIG. 5 is a diagram illustrating multiple time horizons that may be associated with operation of the electronic device of FIG. 1.

FIG. 6 is a diagram illustrating an example of a classification process that may be performed by the electronic device of FIG. 1.

FIG. 7 is a diagram of an illustrative method of generating data indicating geographic locations and index scores associated with the geographic locations that may be performed by the electronic device of FIG. 1.

FIG. 8 is a block diagram of an illustrative example of an electronic device, such as the electronic device of FIG. 1.

FIG. 9 is a block diagram of an illustrative example of a base station that may correspond to the electronic device of FIG. 1.

### V. DETAILED DESCRIPTION

Aspects of the disclosure are related to acoustic event enabled geographic mapping. In a particular example, an electronic device is configured to receive first data that indicates samples of sounds detected at a plurality of geographic locations. The electronic device is configured to determine a plurality of acoustic event classifications associated with the plurality of geographic locations. For example, in response to detecting vehicle noise in a particular sample detected at a particular location, the electronic device may classify the particular location with a traffic classification.

The electronic device is configured to determine a plurality of index scores associated with the plurality of geographic locations by ranking each of the plurality of geographic locations based on the plurality of acoustic event classifications. For example, the electronic device may assign each geographic location a “score” based on one or more acoustic events detected at the geographic location. In an illustrative example, the score indicates a rating associated with the geographic location, such as a “livability” rating associated with the geographic location.

The electronic device is configured to generate, based on the plurality of index scores, second data indicating a geographic map corresponding to the plurality of geographic locations. The second data further indicates the plurality of index scores and a prompt to enable a search for a particular type of acoustic event. The second data may include instructions executable by the electronic device (or another device) to present a graphical user interface that indicates the plurality of geographic locations, the plurality of index scores, and the prompt. Other illustrative aspects are described below with reference to the drawings.

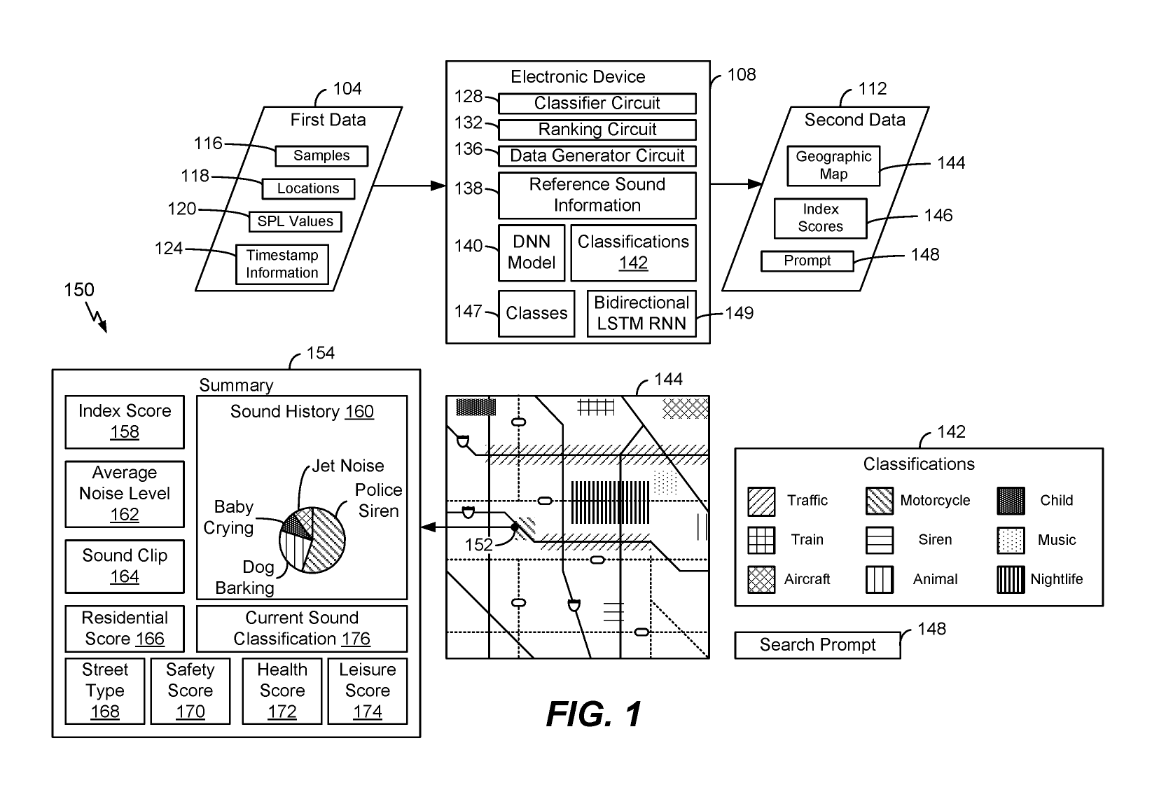

FIG. 1 illustrates certain aspects of a particular example of an electronic device 108. The electronic device 108 is configured to perform acoustic event enabled geographic mapping operations. In some implementations, the electronic device 108 corresponds to a server. Alternatively or in addition, one or more components of the electronic device 108 may be integrated within a mobile device, a base station, or another electronic device.

The electronic device 108 includes a classifier circuit 128, a ranking circuit 132, and a data generator circuit 136. The ranking circuit 132 may be coupled to the classifier circuit 128, to the data generator circuit 136, or to both. For example, the classifier circuit 128 may be coupled to an input of the ranking circuit 132, and the data generator circuit 136 may be coupled to an output of the ranking circuit 132.

During operation, the electronic device 108 may receive first data 104. The first data 104 indicates samples 116 of sound detected at a plurality of geographic locations 118. For example, each sample of the samples 116 may be associated with one or more corresponding geographic locations of the plurality of geographic locations 118. In an illustrative example, first data 104 indicates latitude and longitude information that associates the samples 116 with the plurality of geographic locations 118. In some cases, the samples 116 may correspond to audio samples included in a video recording (e.g., a video recording generated by a camera and a microphone of a mobile device, as an illustrative example).

In some implementations, one or more of the samples 116 may be received from dedicated sensors, such as “fixed” microphones positioned at the plurality of geographic locations 118. For example, a particular microphone may be positioned at a street corner (e.g., within a utility fixture, such as a street light), at a telecommunications device (e.g., a base station), within a building, within a particular room of a building, at a public venue (e.g., a shopping center or a store), at one or more other locations, or a combination thereof. Alternatively or in addition, one or more of the samples 116 may be received from a mobile device of a user (e.g., using a “crowdsourcing” technique). For example, in some implementations, an application (e.g., a smart phone app) may be downloaded by a user to a mobile device, and the application may use a microphone of the mobile device to record one or more of the samples 116. The samples 116 may be stored at and retrieved from a memory (e.g., a cloud storage memory) or may be streamed in “real-time” (or near real-time) from a particular location of the plurality of geographic locations 118.

The classifier circuit 128 is configured to determine a plurality of acoustic event classifications 142 associated with the plurality of geographic locations 118 based on the first data 104. To illustrate, the classifier circuit 128 may classify each of the samples 116 to determine the plurality of acoustic event classifications 142, such as by selecting the plurality of acoustic event classifications 142 from classes 147 of acoustic events. In this case, the plurality of acoustic event classifications 142 may correspond to a subset of the classes 147. To further illustrate, the plurality of acoustic event classifications 142 may include one or more of a traffic classification, a train classification, an aircraft classification, a motorcycle classification, a siren classification, an animal classification, a child classification, a music classification, a nightlife classification, or one or more other classifications.

In some cases, the a particular sample of the samples 116 may be associated with multiple classifications of the plurality of acoustic event classifications, such as if the sample indicates music and nightlife, as an illustrative example. In some implementations, the plurality of acoustic event classifications 142 may include an “unknown” classification, and a particular sample of the samples 116 may be associated with the “unknown” classification if none of the other classifications of the plurality of acoustic event classifications 142 can be associated with the particular sample (e.g., within a particular confidence interval). In some implementations, the plurality of acoustic event classifications 142 may be “weighted.” For example, each acoustic event classification associated with a particular sample may be assigned a particular weight, such as if the particular sample is assigned a 60 percent nightlife classification and a 40 percent music classification, as an illustrative example.

In some implementations, the classifier circuit 128 is configured to determine the plurality of acoustic event classifications 142 by comparing the samples to reference sound information 138. The reference sound information 138 may include samples that are representative of certain acoustic events and information that is associated with the types of acoustic events. For example, the reference sound information 138 may include a sample of siren noise and a value that is associated with siren noise.

As used herein, a circuit may include hardware (e.g., digital circuitry, analog circuitry, or both), a processor configured to access a computer-readable medium that stores processor-executable instructions, or a combination thereof. To illustrate, the classifier circuit 128 may include a comparator circuit having a first input configured to receive samples of the samples 116 and a second input configured to receive reference samples of the reference sound information 138. The comparator circuit may be configured to compare the samples and the reference samples. The comparator circuit may include an output configured to generate a third signal indicating a “match” between a sample and a reference sample. Alternatively or in addition, the classifier circuit 128 may include a processor configured to access a memory to retrieve instructions and to execute the instructions to perform one or more operations described herein, such as by executing a compare instruction to compare the sample and the reference sample, as an illustrative example.

As another example, the ranking circuit 132 may include a multiplication circuit configured to “weight” characteristics of samples associated with a geographic location, such as by weighting a first value associated with a nightlife acoustic event by 60 percent and by weighting a second value associated with a music acoustic event by 40 percent (in response to detecting that 60 percent of acoustic events at the geographic location are associated with a nightlife classification and that 40 percent of acoustic events at the geographic location are associated with a music classification). In some implementations, the ranking circuit 132 may further include an addition circuit configured to add the weighted first value and the weighted second value to generate an index score of the plurality of index scores 146. Alternatively or in addition, the ranking circuit 132 may include a processor configured to access a memory to retrieve instructions and to execute the instructions to perform one or more operations described herein, such as by executing a multiplication instruction to generate the weighted first value and the weighted second value and by executing an addition instruction to add the weighted first value and the weighted second value, as an illustrative example.

As another example, the data generator circuit 136 may include circuit configured to generate a file that complies with a file format, such as by transcoding data to generate the second data 112, by compressing data to generate the second data 112, by performing one or more other operations, or a combination thereof. Alternatively or in addition, the data generator circuit 136 may include a processor configured to access a memory to retrieve instructions and to execute the instructions to perform one or more operations described herein.

To further illustrate, for each sample of the samples 116, the classifier circuit 128 may compare an amplitude of the sample to amplitudes of samples of the reference sound information 138. Alternatively or in addition, for each sample of the samples 116, the classifier circuit 128 may compare a frequency of the sample to frequencies of samples of the reference sound information 138. Alternatively or in addition, for each sample of the samples 116, the classifier circuit 128 may compare a phase of the sample to phases of samples of the reference sound information 138. The classifier circuit 128 may be configured to associate a particular sample of the samples 116 with a reference sample of the reference sound information 138 if one or more characteristics of the particular sample (e.g., amplitude, frequency, phase, or one or more other characteristics) match corresponding characteristics of the reference sample (e.g., within a particular confidence interval).

The first data 104 may optionally indicate a plurality of sound pressure level (SPL) values 120 associated with the plurality of geographic locations 118. For example, each sample of the samples 116 may be associated with a respective SPL value of the plurality of SPL values 120. The classifier circuit 128 may be configured to determine the plurality of acoustic event classifications 142 further based on the plurality of SPL values 120. For example, in some cases, a particular classification of the plurality of acoustic event classifications 142 may be weighted less (or may be “disqualified” from consideration) in response to a relatively low SPL level indicated by the plurality of SPL values 120. To illustrate, if a particular sample of the samples 116 matches an aircraft classification and if an SPL value associated with the particular sample fails to satisfy a threshold, then the classifier circuit 128 may “disqualify” aircraft classification for the particular sample (or may assign the aircraft classification a lower weight). Alternatively, a particular classification of the plurality of acoustic event classifications 142 may be weighted more in response to a relatively high SPL level indicated by the plurality of SPL values 120. To illustrate, if a particular sample of the samples 116 matches an aircraft classification and if an SPL value associated with the particular sample satisfies a threshold, then the classifier circuit 128 may assign the aircraft classification a greater weight.

The first data 104 may optionally indicate timestamp information 124 associated with the plurality of geographic locations 118. For example, each sample of the samples 116 may be associated with a respective timestamp of the timestamp information 124. The classifier circuit 128 may be configured to determine the plurality of acoustic event classifications 142 further based on the timestamp information 124. For example, in some cases, a particular classification of the plurality of acoustic event classifications 142 may be weighted less (or may be “disqualified” from consideration) in response to the timestamp information 124. To illustrate, if a particular sample of the samples 116 matches a nightlife classification and if a timestamp associated with the particular sample indicates daytime, the classifier circuit 128 may “disqualify” nightlife classification for the particular sample (or may assign the nightlife classification a lower weight). Alternatively, a particular classification of the plurality of acoustic event classifications 142 may be weighted more in response to a timestamp indicated by the timestamp information 124. To illustrate, if a particular sample of the samples 116 matches a traffic classification and if a timestamp associated with the particular sample indicates a rush hour time of day, then the classifier circuit 128 may assign the traffic classification a greater weight.

Alternatively or in addition, the classifier circuit 128 may be configured to determine the plurality of acoustic event classifications 142 based on a deep neural network (DNN) model 140. The DNN model 140 may include a set of input nodes, a set of output nodes, and a set of intermediate (or “hidden”) nodes. Each output node of the DNN model 140 may correspond to one or more respective acoustic event classifications of the plurality of acoustic event classifications 142. For each output node of the DNN model 140, the classifier circuit 128 may assign a classification probability to a particular sample of the samples 116, where the classification probability indicates a likelihood that the sample has the particular characteristic (e.g., based on how closely the sample matches a reference sample of the reference sound information 138).

Alternatively or in addition to using the DNN model 140, the electronic device 108 is configured to perform one or more operations based on a bidirectional long short term memory (LSTM) recurrent neural network (RNN) 149. The classifier circuit 128 may be configured to evaluate the samples 116 based on the bidirectional LSTM RNN 149, such as by performing multiple evaluations of the samples 116 using multiple time scales (also referred to herein as time horizons). For example, the classifier circuit 128 may be configured to perform a first evaluation of the samples 116 based on a first time scale, a second evaluation of the samples 116 based on a second time scale, and a third evaluation of the samples 116 based on a third time scale. In an illustrative example, the first time scale may correspond to 40 milliseconds (ms), the second time scale may correspond to 60 ms, and the third time scale may correspond to 120 ms. Other sample sizes, other time horizon sizes, or both, may be used in some implementations.

In some cases, use of multiple time horizons may assist in “learning” properties of the geographic locations 118 in order to generate the plurality of acoustic event classifications based on the first data 104. For example, in some cases, certain acoustic events may occur relatively infrequently. As an illustrative example, a festival event may occur once a year. In this case, analyzing samples using a relatively long time scale (e.g., one or more years) may assist in classifying a particular location of the plurality of geographic locations that is associated with a festival event. Alternatively or in addition, certain acoustic events may occur with a relatively short duration. As an illustrative example, a siren event may have a relatively short duration (e.g., as compared to a festival event). In this case, analyzing samples using a relatively short time scale (e.g., a time scale of several seconds) may assist in classifying a particular location of the plurality of geographic locations that is associated with a siren event.

In some implementations, use of one or more of the DNN model 140 or the LSTM RNN 149 enables masking of information that may identify one or more persons. For example, the electronic device 108 may delete one or more of the samples 116 upon using one or more of the DNN model 140 or the LSTM RNN 149 to classify the samples 116, such as by deleting a sample that includes the voice of a user or other user-identifiable information.

Depending on the particular implementation, the plurality of acoustic event classifications 142 may indicate historical (or “long term”) classifications of the plurality of geographic locations 118, “real time” (or near real time) classifications of the plurality of geographic locations 118, or both. For example, the samples 116 may be used in connection with a previous set of samples associated with the plurality of geographic locations 118, such as combining classifications indicated by the samples 116 and the previous set of samples. In some implementations, the classifier circuit 128 may “evict” or “overwrite” a classification associated with a particular geographic location of the plurality of geographic locations 118 if the classification has not been detected within a threshold amount of time, a threshold number of samples, or a combination thereof.

The ranking circuit 132 is configured to determine a plurality of index scores 146 associated with the plurality of geographic locations 118 by ranking each of the plurality of geographic locations 118 based on the plurality of acoustic event classifications 142. As used herein, “ranking” the plurality of geographic locations 118 may include assigning one or more values, scores, or other indications to the plurality of geographic locations 118. As used herein, “ranking” the plurality of geographic locations 118 may not necessarily include sorting the plurality of geographic locations 118 or determining a hierarchy of the plurality of geographic locations 118.

In some implementations, the plurality of index scores 146 may be selected from a range of numeric values, such as from a range of integers of 1 to 100. Alternatively or in addition, the index scores may have non-numeric components, such as letter grades (e.g., “A” through “F”), a number of stars (e.g., five stars to zero stars), one or more other components, or a combination thereof.

In some examples, a higher index score indicates a more desirable ambient noise characteristic, and a lower index score indicates a less desirable ambient noise characteristic. As a non-limiting illustrative example, a first geographic location having an index score of 90 out of 100 may be associated with more desirable ambient noise characteristics than a second geographic location having an index score of 50 out of 100, such as if the first geographic location corresponds to a relatively quiet residential neighborhood and if the second geographic location is affected by noise from a highway.

Depending on the particular implementation, each geographic location of the plurality of geographic locations 118 may be associated with one index score of the plurality of index scores 146 or with multiple index scores of the plurality of index scores 146. To illustrate, in some examples, the plurality of index scores 146 correspond to “overall” (or “general”) scores, and each geographic location of the plurality of geographic locations 118 may be associated with one index score of the plurality of index scores 146. In other examples, the plurality of index scores 146 may include multiple different types of rankings for one or more geographic locations of the plurality of geographic locations 118. To illustrate, for each geographic location of the plurality of geographic locations 118, the plurality of index scores 146 may include one or more of a neighborhood score, a livability score, a safety rating, a health score, a leisure score, one or more other scores, or a combination thereof.

In a particular example, the ranking circuit 132 is configured to determine a particular index score of the plurality of index scores 146 that is associated with a particular sample of the samples 116 based on one or more of the plurality of acoustic event classifications 142 that are associated with the particular sample. To illustrate, if the particular sample is associated with a nightlife classification and with a music classification, the ranking circuit 132 may determine the particular index score based on a first value associated with the nightlife classification and a second value associated with the nightlife classification (e.g., by averaging the first value and the second value). In some cases, the first value may be different from the second value. For example, if a music classification is more desirable than a nightlife classification, then the first value may be greater than the second value. Further, values used to determine the particular index score may be weighted, such as by weighting a value based on a percentage match associated with the value (e.g., based on how closely the particular sample matches one or more of the acoustic event classifications 142). To illustrate, if the particular sample is associated with a music classification based on a 60 percent match and with a nightlife classification based on a 40 percent match, the ranking circuit 132 may assign a first weight (e.g., 60 percent) to the first value and may assign a second weight (e.g., 40 percent) to the second value.

The data generator circuit 136 is configured to generate second data 112 based on the plurality of index scores 146. The second data 112 indicates a geographic map 144 corresponding to the plurality of geographic locations 118. For example, the second data 112 may include instructions (e.g., a program or an application) executable by an electronic device (e.g., a server, a smart phone, a computer, or another electronic device) to present the geographic map 144 and the plurality of index scores 146 to a user via a display device. In another example, the second data 112 may be usable by a map application or a map program, such as if the second data 112 includes a “plugin” for a map application or a map program. As used herein, the second data 112 may include “geo-acoustic” data that specifies certain acoustic properties (e.g., based on the plurality of index scores 146) associated with geographic locations (e.g., the plurality of geographic locations 118 corresponding to the geographic map 144).

In some examples, data representing one or more portions of the geographic map 144 may be provided from a third party source, such as from a cartographer. The data generator circuit 136 may be configured to generate the second data 112 by associating the plurality of index scores 146 with geographic locations of the geographic map 144, such as by matching latitude and longitude information associated with the plurality of index scores 146 (based on the plurality of geographic locations 118) with locations of the geographic map 144. In other examples, the data generator circuit 136 may be configured to generate data representing one or more portions the geographic map 144, such as based on zoning information associated with the plurality of geographic locations 118, images (e.g., satellite images or user images) associated with the geographic locations 118, business information associated with the geographic locations 118, cartographic or surveying information associated with the plurality of geographic locations 118, street information associated with the plurality of geographic locations 118, other information, or a combination thereof. The second data 112 further indicates a prompt 148 to enable a search for a particular type of acoustic event. For example, the prompt 148 may include a text box to receive text input from a user to indicate a particular type of acoustic event, as described further below.

To further illustrate, FIG. 1 depicts an illustrative example of a graphical user interface (GUI) 150 associated with the second data 112. For example, the second data 112 may include instructions executable by an electronic device to present the GUI 150 at a display device. Depending on the particular example, the GUI 150 may be presented by the electronic device 108 or by another electronic device 108 that receives the second data 112 from the electronic device 108. For example, the second data 112 may be received from the electronic device 108 via a network (e.g., the Internet, a local area network (LAN), one or more other networks, or a combination thereof) by one or more of a server, a mobile device, a computer, or another electronic device that presents the GUI 150.

The GUI 150 includes the geographic map 144 and indications of one or more acoustic event classifications, such as the plurality of acoustic event classifications 142. In the GUI 150, the plurality of acoustic event classifications 142 may be indicated in the geographic map 144 using shading or crosshatching patterns. Alternately or in addition, the plurality of acoustic event classifications 142 may be indicated in the geographic map 144 using a color coded scheme, symbols, one or more other techniques, or a combination thereof.

The prompt 148 enables a user to search the geographic map 144 or another region indicated by the second data 112 for one or more types of acoustic events. To illustrate, the prompt 148 may include a text box. If a user searches for “fireworks” using the text box, an electronic device presenting the GUI 150 may search the plurality of acoustic event classifications 142 for a “fireworks” event. It is noted that in this case, the search is based at least in part on the samples 116 (since for example the plurality of acoustic event classifications 142 are based on the samples 116), which may result in a more efficient or complete search as compared to a “text-only” technique that classifies and searches for sound categories without reference to acoustic information.

Alternatively in addition, the prompt 148 may include one or more other types of prompts, such as a graphic-based prompt. To illustrate, the prompt 148 may include one or more icons depicting certain types of acoustic events, and a user may initiate a search by selecting one or more icons of the prompt 148. As an illustrative example, the prompt 148 may indicate a fireworks icon that is selectable by a user. In some implementations, one or more icons indicated by the prompt 148 may be selected based on one or more temporal characteristics, such as a time of day, a day of the week, a month, a season, or a holiday during which with GUI 150 is presented. As an illustrative example, a fireworks icon may be presented in the GUI 150 during a new year celebration time of year.

Alternatively or in addition, in some implementations, the prompt 148 may include (or may be used in connection with) an audio interface configured to receive audio (e.g., from a user) and to initiate a search based on the audio. To illustrate, a user may speak a phrase, and a search may be initiated based on one or more words recognized in the phrase (e.g., using a speech recognition technique). In another example, a user may introduce a representative “sample” of a certain noise to “match” the noise with one or more types of acoustic events. In some examples, the second data 112 includes instructions executable by a processor an electronic device to perform a speech recognition process, an acoustic event matching process, or both. In other implementations, another technique may be used. For example, samples of audio indicating a search may be “off-loaded” to another device (e.g., via the Internet, another network, or a combination thereof). As a particular illustrative example, the GUI 150 may be presented at an electronic device that sends samples of audio indicating a search to the electronic device 108 to enable the electronic device 108 to perform an acoustic event matching process using the classifier circuit 128.

In response to a search initiated via input at the prompt 148 indicating one or more types of acoustic events, the GUI 150 may present one or more results (or “hits”) of the search. For example, the second data 112 may include instructions executable to update the geographic map 144 based on the search, such as by adding one or more icons to the geographic map 144 to indicate the one or more types of acoustic events. To illustrate, in response to a search for fireworks received via input at the prompt 148, the second data 112 may include instructions executable to overlay one or more fireworks icons at one or more locations of the geographic map 144 (e.g., in response to determining that the one or more locations are associated with a fireworks type of acoustic event classification of the plurality of acoustic event classifications 142). In some examples, the GUI 150 may enable a user to zoom out of the geographic map 144 (e.g., using a zoom tool) to increase a number of results of the search that are displayed in the geographic map 144.

In a particular example, the GUI 150 enables a user to select one or more locations from the geographic map 144 for additional information, such as by clicking, tapping, or hovering a cursor over the geographic map 144. To illustrate, in response to selection of a particular location 152, the GUI 150 may present a summary 154 associated with the particular location 152. The summary 154 also indicates an index score 158 that is associated with the particular location 152 and that is included in the plurality of index scores 146. The particular location 152 is included in the plurality of geographic locations 118.

The summary 154 may indicate a sound history 160 associated with the particular location 152. For example, the sound history 160 may indicate one or more acoustic events detected at the particular location 152 based on one of more acoustic events of the plurality of acoustic event classifications 142 that are associated with the particular location 152. To further illustrate, the particular example of FIG. 1 indicates that the particular location 152 may be associated with a siren classification (e.g., due to detection of a police siren), an animal classification (e.g., due to detection of a dog barking), a child classification (e.g., due to detection of a baby crying), and an aircraft classification (e.g., due to detection of a jet noise).

In the example of FIG. 1, the sound history 160 includes a pie chart graphic that illustrates a percentage breakdown of acoustic events at the particular location 152. For example, the percentage breakdown may be based on frequency of occurrence of the acoustic events, by amplitude of the acoustic events, by one or more other criteria, or a combination thereof. Alternatively or in addition to a pie chart graphic, the sound history 160 may indicate other information, such as a bar graph, a Cartesian coordinate plot, other information, or a combination thereof.

The sound history 160 may be associated with a particular time frame. For example, the sound history 160 may correspond to a one year sound history that indicates sounds detected at the particular location 152 for a period of twelve months. In another example, the sound history 160 may be searchable by a date range (e.g., a month sound history, a five year sound history, or another time data range), by particular days (e.g., February 8), or by a range between particular days.

The summary 154 may further indicate an average noise level 162 associated with the particular location 152. For example, the average noise level 162 may correspond to one of the SPL values 120 or an average of multiple SPL values of the SPL values 120.

The summary 154 may also indicate a sound clip 164. In a particular example, selection of the sound clip 164 (e.g., by clicking, tapping, or hovering a cursor over the sound clip 164 in the GUI 150) causes generation of audio of one or more representative acoustic events associated with the particular location 152. For example, if a police siren is a most frequently occurring event or is the event with the greatest amplitude associated with the particular location 152, then the sound clip 164 may include a police siren audio sample. In some implementations, the sound clip 164 may include “real” audio detected at the particular location. For example, the sound clip 164 may include one or more samples of the samples 116. In other implementations, the sound clip 164 may include a “stock” audio sample, such as a “stock” sample retrieved from a database of sound samples.

The summary 154 may also indicate a current sound classification 176 associated with the particular location 152. For example, in some implementations, one or more of the samples 116 may be provided to the electronic device 108 in “real time” (or approximately real time, such as using a data streaming technique), and the electronic device 108 may generate the second data 112 “on the fly.” In this example, the current sound classification 176 may indicate in real time a sound detected at the particular location 152. In some implementations, a user may “preview” the audio associated with the current sound classification 176 (e.g., by clicking, tapping, or hovering a cursor over the current sound classification 176). Alternatively or in addition, the current sound classification 176 may provide a graphical indication of current sound classification, such text or an icon. For example, to indicate a traffic classification, the current sound classification 176 may indicate the word “traffic,” a vehicle icon, other graphical information, or a combination thereof.

The summary 154 may also indicate one or more of a residential score 166 associated with the particular location 152, a street type 168 associated with the particular location 152, a safety score 170 associated with the particular location, a health score 172 associated with the particular location 152, or a leisure score 174 associated with the particular location 152. One or more of the residential score 166, the street type 168, the safety score 170, the health score 172, or the leisure score 174 may be determined (e.g., by the electronic device 108) based on the first data 104, based on other information, or a combination thereof. For example, one or more of the residential score 166, the street type 168, the safety score 170, the health score 172, or the leisure score 174 may be determined based on zoning information associated with the plurality of geographic locations 118, images (e.g., satellite images or user images) associated with the geographic locations 118, business information associated with the geographic locations 118, cartographic or surveying information associated with the plurality of geographic locations 118, street information associated with the plurality of geographic locations 118, weather information associated with the plurality of geographic locations 118, other information, or a combination thereof.

The residential score 166 may indicate a “livability” associated with the particular location 152 determined by the electronic device 108 based on the samples 116. For example, the electronic device 108 may determine a lower value of the residential score 166 if the particular location 152 matches one or more of the plurality of acoustic event classifications 142 (e.g., with a high likelihood of traffic being present near the particular location 152). In some cases, if the particular location 152 is a business-zoned location (or other non-residential location), the residential score 166 may indicate that the particular location 152 is non-residential.

The street type 168 may indicate a type of street associated with the particular location 152, such as whether the particular location 152 is located at a busy street, a business street, a residential street, a cul-de-sac, a multi-lane street, a one-way street, another street type, or a combination thereof. In some implementations, the residential score 166 may be determined based in part on the street type 168.

The safety score 170 may indicate a safety rating associated with the particular location 152. For example, in some implementations, a greater match with a traffic classification may decrease the safety score 170 (e.g., due to injuries or fatalities that may be associated with a high traffic region). Alternatively or in addition, the data generator circuit 136 may be configured to receive crime statistics information and to determine the safety score 170 based at least in part on the crime statistics information.

The health score 172 may indicate a health rating associated with the particular location 152. For example, in some implementations, a greater match with an industrial classification may decrease the health score 172 (e.g., due to health risks that may be associated with industrial chemicals). As another example, a greater match with a recreational classification may increase the health score 172, such as if the particular location 152 is near an exercise facility (e.g., due to health benefits that may be associated with use of exercise facilities). Alternatively or in addition, the data generator circuit 136 may be configured to receive health statistics information (e.g., mortality rates) and to determine the health score 172 based at least in part on the health statistics information.

The leisure score 174 may indicate a leisure rating associated with the particular location 152. For example, in some implementations, a greater match with a recreational classification may increase the leisure score 174, such as if the particular location 152 is near one or more recreational facilities, such as a spa or an art studio (e.g., due to health benefits that may be associated with use of recreational facilities). Alternatively or in addition, the data generator circuit 136 may be configured to receive information (e.g., indicating how “active” residents are in one or more leisure activities) and to determine the leisure score 174 based at least in part on the information.

In some implementations, the second data 112 may be used in connection with an emergency response service. For example, a police dispatcher or an ambulance dispatcher may use the GUI 150 to identify an emergency situation (e.g., based on a gunshot acoustic event, an explosion acoustic event, or other activity, such as screaming or crying). In some implementations, one or more sensors used to generate the first data 104 may be integrated within a police box.

Alternatively or in addition, the GUI 150 may be used to monitor environmental criteria, such as noise pollution. To illustrate, a governmental agency may use the second data 112 in connection with city planning, traffic control, infrastructure spending, or other decisions.

Alternatively or in addition, the second data 112 may be used in connection with a real estate service, a travel service, or a tourism service. For example, a website may rank homes, restaurants, or hotels based on types of acoustic events detected using the first data 104. In some implementations, the GUI 150 may include one or more “filter” options, such as one or more options to list homes, restaurants, or hotels that match one or more acoustic events or to exclude homes or hotels based on types of acoustic events. As an illustrative example, the GUI 150 may enable a user to identify a dog-friendly neighborhood, a child-friendly neighborhood, a neighborhood with nightlife or leisure activities, a jet noise free neighborhood, a racing-friendly neighborhood that allows street racing activities, or a police siren free neighborhood, as illustrative examples. As another illustrative example, the GUI 150 may enable a user to identify a restaurant or a bar based on a particular preference, such as a kids-friendly restaurant, a group-friendly restaurant, a restaurant or bar with live music, a football-friendly bar, or a quiet cafe suitable for reading or studying, as illustrative examples.

Alternatively or in addition, the second data 112 may be used in connection with a predictive analytics technique. For example, the second data 112 may be used to generate a model, such as a consumer behavior model or a criminal behavior model. As an illustrative example, the classifier circuit 128 may detect a correlation between certain types of acoustic events, such as by determining that a first type of acoustic event is followed by a second type of acoustic event within a particular time interval or within a particular geographic distance with a particular probability. In this case, the classifier circuit 128 may be configured to predict an acoustic event of the second type in response to detecting an acoustic event of the first type. As a non-limiting illustrative example, the classifier circuit 128 may be configured to predict a call for emergency services in response to detecting a particular type of acoustic event, such as gunshot event.

In some implementations, one or more operations described herein may be performed based on an identity of a source of one or more samples indicated by the first data 104. To illustrate, a device that generates a particular set of samples of the samples 116 may provide a source indication, such as a media access control (MAC) address or a username associated with a user of the device, as illustrative examples. In this case, the second data 112 may enable activity pattern tracking, such as by detecting a pattern of activities of a human or a robot. As an illustrative example, by detecting acoustic events and geographic locations based on the first data 104, the electronic device 108 may determine that one or more users prefer to drive a motorcycle to work on certain days of the week or during certain types of weather.

In some implementations, a service may be suggested to a user or a device configuration may be adjusted based on the second data 112. For example, the GUI 150 may prompt a user to indicate whether an emergency is occurring in response to detecting a siren acoustic event based on the first data 104. As another example, an audio configuration (e.g., a microphone configuration or a speaker configuration) may be selected based on the second data 112, such as by tuning from a single microphone configuration to a multi-microphone configuration or by activating a speech processing feature based on the second data 112.

In some implementations, an automatic metadata generation process may be performed based on the second data 112 (e.g., to “tag” a media content item, such as a video recording or an audio recording). For example, by detecting an animal acoustic event (e.g., a dog barking) in a video recording based on one or more of the samples 116, the electronic device 108 may generate a metadata tag indicating that the video recording includes or may include pet content.

One or more examples described with reference to FIG. 1 may increase convenience associated with use of the geographic map 144. For example, the samples 116 may enable classification of acoustic event characteristics associated with a location, such as the particular location 152. As a result, use of one or more aspects of FIG. 1 may address certain technical problems, such as difficulty in classifying acoustic events. For example, using the samples 116 by the electronic device 108 to classify acoustic events as described with reference to FIG. 1 may reduce or avoid reliance on “manual” classification of acoustic events or “proximity-based” classification (e.g., where a geographic location proximate to a factory is “assumed” to experience industrial noise).

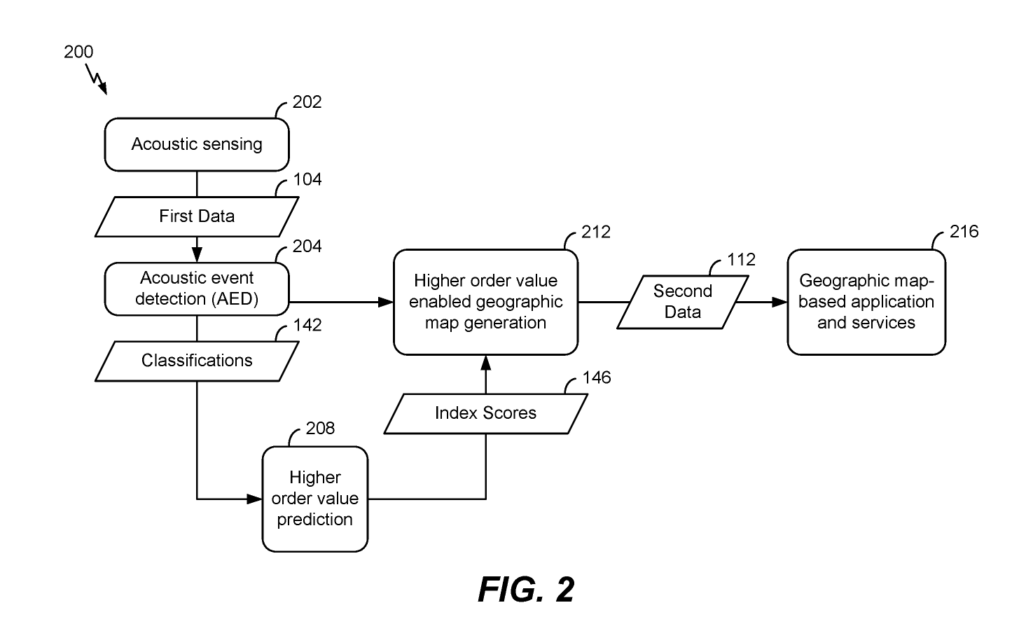

Referring to FIG. 2, an illustrative example of a set of operations is depicted and generally designated 200. In an illustrative example, the operations 200 may be performed by the electronic device 108 of FIG. 1.

The operations 200 include performing an acoustic sensing operation, at 202. The acoustic sensing operation may be performed to generate the first data 104 of FIG. 1. To illustrate, the acoustic sensing operation may be performed using the samples 116, such as by using a crowd-sensing infrastructure. The crowd-sensing infrastructure may include “fixed” sensors installed at public locations, such as within or coupled to a light pole, a bus, a train, a trash bin, or a police box, as illustrative examples. Alternatively or in addition, the crowd-sensing infrastructure may include mobile devices, such as a microphone or a location sensor (e.g., a Global Positioning System (GPS) sensor) of a mobile phone, a wearable device, or an Internet of Things (IoT) device, as illustrative examples. In some implementations, sensors of the crowd-sensing infrastructure perform the acoustic sensing operation to generate the first data 104 and communicate the first data 104 to the electronic device 108 of FIG. 1.

The operations 200 further include performing an acoustic event detection (AED) operation (e.g., based on the first data 104), at 204. The AED operation is performed based on the samples 116 of FIG. 1. The AED operation may be performed further based on one or more of location information associated with the plurality of geographic locations 118 (e.g., latitude and longitude), the plurality of SPL values 120, the timestamp information 124, other information, or a combination thereof. In a particular example, the AED operation is performed by the electronic device 108 of FIG. 1 (e.g., using the classifier circuit 128) to generate the plurality of acoustic event classifications 142 of FIG. 1. In a particular example, the electronic device 108 receives the first data 104 from the crowd-sensing infrastructure described with reference to the acoustic sensing operation, such as via a wired network, a wireless network (e.g., a cellular network, wireless local area network (WLAN), or another network), one or more other networks, or a combination thereof.

The operations 200 further include performing a higher order value prediction operation based on the plurality of acoustic event classifications 142, at 208. For example, the ranking circuit 132 may rank (e.g., score) the plurality of geographic locations 118 based on the plurality of acoustic event classifications 142 to generate the plurality of index scores 146. As used herein, a “higher order” value may refer to a value (e.g., an index score) that is based on or that indicates one or more subjective qualities associated with a geographic location, such as a desirability of a geographic location. In some implementations, a higher order value prediction operation may include generating a value that indicates (or “predicts”) a desirability of a geographic location based on the samples 116 of FIG. 1. As an illustrative example, the higher order value prediction operation may include “predicting” a relatively low desirability of a geographic location due to detecting traffic at the geographic location based on the samples 116.

The operations 200 further include generating a higher order value enabled geographic map, at 212. For example, the higher order value enabled geographic map may correspond to the second data 112. The higher order value enabled geographic map may be generated by the data generator circuit 136 of FIG. 1.

The operations 200 further include providing a geographic map-based application, performing one or more geographic map based services, or a combination thereof, at 216. For example, the second data 112 may include an application, such as a smart phone application or a computer application that is executable to present the GUI 150 of FIG. 1. As another example, the second data 112 may be usable by a map application or a map program, such as to “overlay” one or more aspects of the GUI 150 within graphical content of the map application or map program. Certain illustrative examples of applications that use the second data 112 may include a real estate application, a business ranking application, a booking application, or a map application. As another example, a service may be provided using the second data 112, such as by providing a real estate service, a business recommendation service, a booking service, or a navigation service, as illustrative examples.

One or more examples described with reference to FIG. 2 may increase convenience associated with use of a geographic map. For example, by generating a higher order value enabled geographic map, applications or services may be enhanced using acoustic event information.

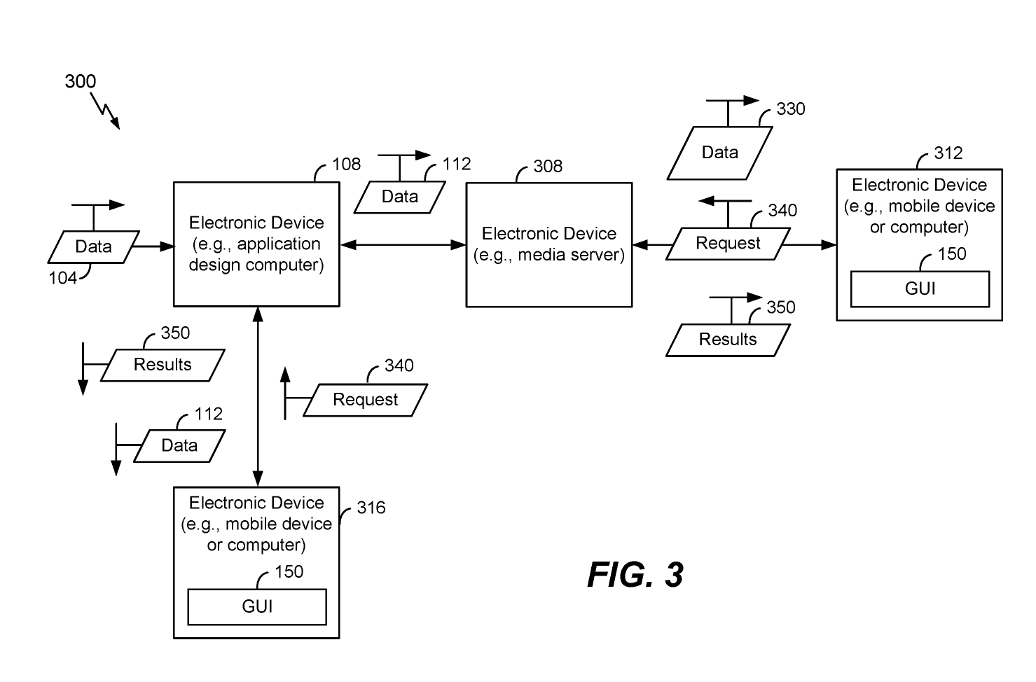

FIG. 3 depicts certain illustrative aspects of an example of a system 300. In FIG. 3, the system 300 includes the electronic device 108. FIG. 3 also illustrates that the system 300 may further include an electronic device 308, an electronic device 312, and an electronic device 316.

In a particular example, the electronic device 108 corresponds to an application design computer. To illustrate, the electronic device 108 may receive the first data 104 and may generate the second data 112, where the second data 112 includes a “standalone” application that is executable by the electronic device 316 (e.g., a mobile device or a computer) to present the GUI 150 (e.g., via a smart phone app or a computer app).

Alternatively or in addition, the second data 112 may be usable by the electronic device 308 to generate third data 330 that is provided to the electronic device 312. For example, the electronic device 308 may correspond to a media server, such as a server of a real estate service, a business ranking service, a booking service, or a map service, as illustrative examples. In a particular example, the third data 330 may include data associated with a website (e.g., real estate website, a business ranking website, a booking website, a map website, or another website) that is accessible to the electronic device 312 (e.g., via the Internet or another network). The electronic device 312 may correspond to a mobile device, a computer, or another electronic device that accesses the website to receive the third data 330 (e.g., via the Internet or another network) in order to the present the GUI 150 (e.g., via a web browser).

In some examples, one or more of the electronic devices 312, 316 may generate data indicating a request for a search, such as by generating a search request 340. For example, the search request 340 may be generated in response to input received via the prompt 148 of FIG. 1. Depending on the particular implementation, the search request 340 may be provided to the electronic device 108, to the electronic device 308, or to both. In response to the search request 340, one or both of the electronic devices 108, 308 may provide one or more search results (e.g., search results 350) indicating a result of the search. In an alternative example, one or more of the second data 112 or the third data 330 may include instructions executable to generate the search results 350).

One or more examples described with reference to FIG. 3 may increase convenience associated with use of a geographic map. For example, by generating a higher order value enabled geographic map, applications or services may be enhanced using acoustic event information, such as by enabling a user to determine (or “predict”) a value of a geographic location based on acoustic properties of the geographic location.

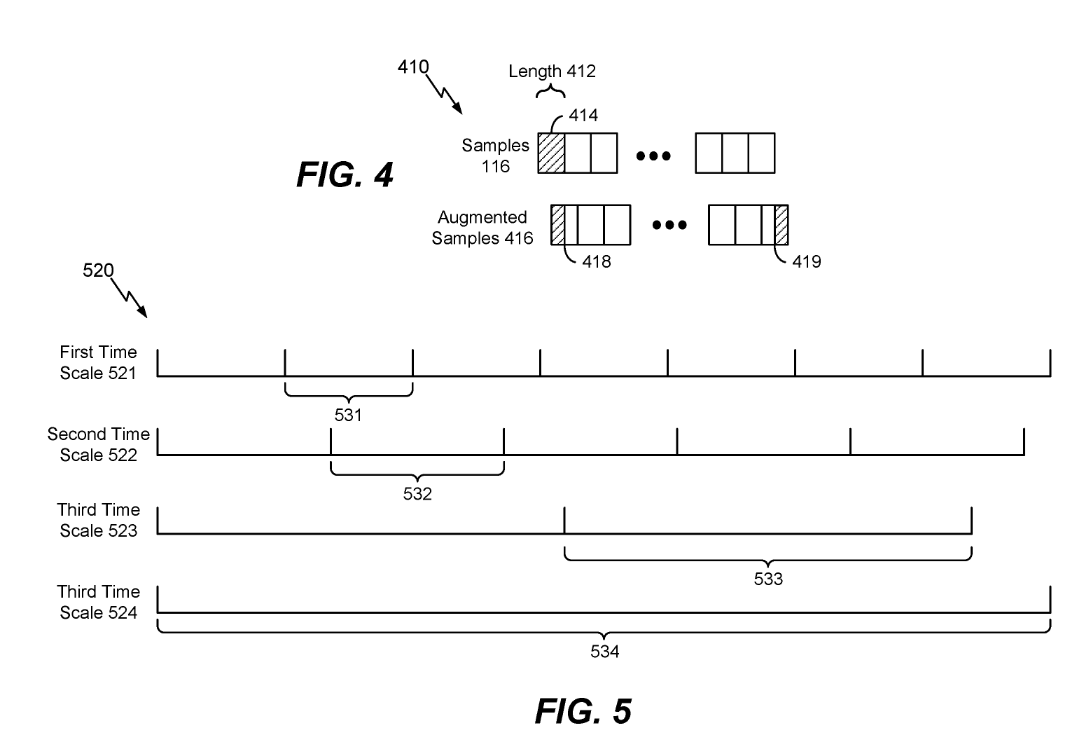

FIG. 4 illustrates an example of a data augmentation process 410. The data augmentation process 410 may be performed to augment samples (e.g., the samples 116, or other samples), such as in connection with a training process.

To illustrate, in some applications, a training process may be performed to enable the electronic device 108 of FIG. 1 to “learn” to detect acoustic events, such as acoustic events corresponding to the plurality of acoustic event classifications 142. For example, in a training process, the samples 116 may include samples detected at a nightlife environment to enable the electronic device 108 to “learn” acoustic characteristics of nightlife environments, such as chatter, dishes clanking, music, etc. In some cases, the samples 116 may be insufficient for training, such as if a large number of samples is to be used during the training process. In this case, the samples 116 may be augmented by creating variations in the samples 116 to generate an augmented data set (e.g., in order to increase a number of samples).

To further illustrate, in FIG. 4, the samples 116 include multiple frames each having a length 412 (e.g., 20 ms, as an illustrative example). To generate augmented samples 416, frame boundaries associated with the samples 116 may be redefined (e.g., “moved”). For example, FIG. 4 illustrates that a portion of a frame 414 of the samples 116 may be “moved” to the end of the samples 116 to generate the augmented samples 416. In the augmented samples 416, a frame 418 includes a portion of the frame 414, and a frame 419 includes another portion of the frame 414. Alternatively or in addition to “moving” one or more frame boundaries, the electronic device 108 may use multiple frame sizes of the samples 116, as described further with reference to FIG. 5.

FIG. 5 depicts a plurality of time scales 520. In the example of FIG. 5, the plurality of time scales 520 includes a first time scale 521, a second time scale 522, a third time scale 523, and a fourth time scale 524.

The first time scale 521 may be associated with a first frame size 531, and the second time scale 522 may be associated with a second frame size 532. FIG. 5 also illustrates that the third time scale 523 may be associated with a third frame size 533 and that the fourth time scale 524 may be associated with a fourth frame size 534. In an illustrative example, the first frame size 531 may correspond to 40 ms, the second frame size 532 may correspond to 60 ms, the third frame size 533 may correspond to 120 ms, and the fourth frame size 534 may correspond to 240 ms.

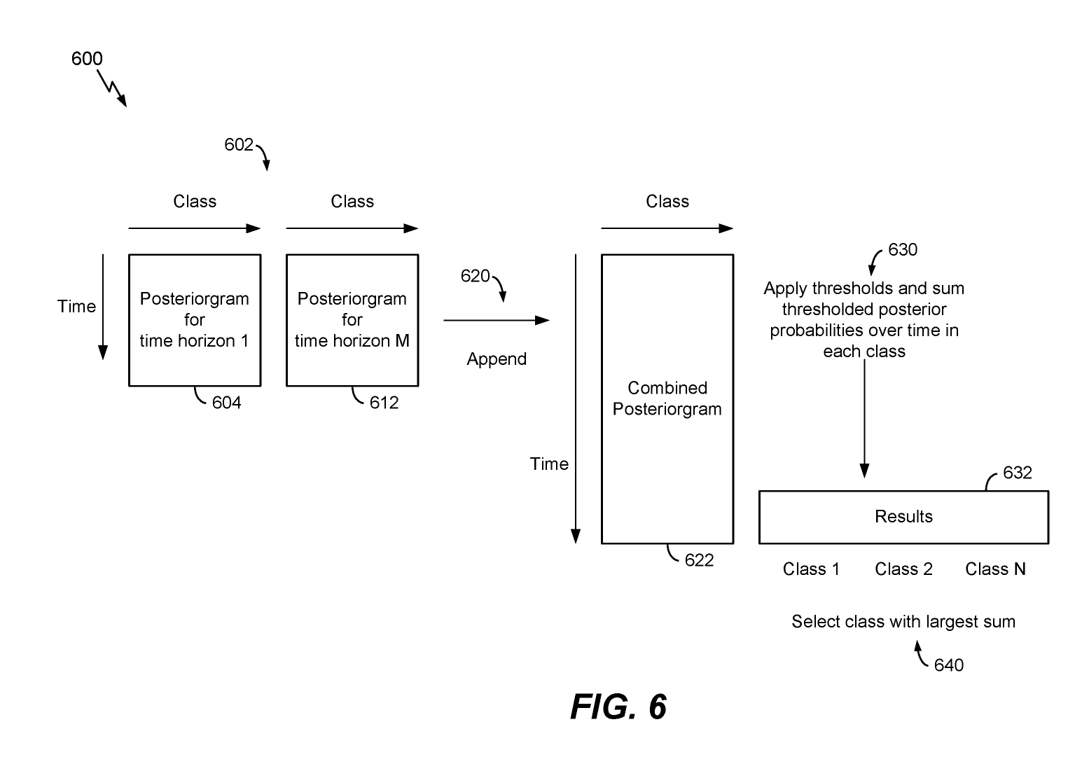

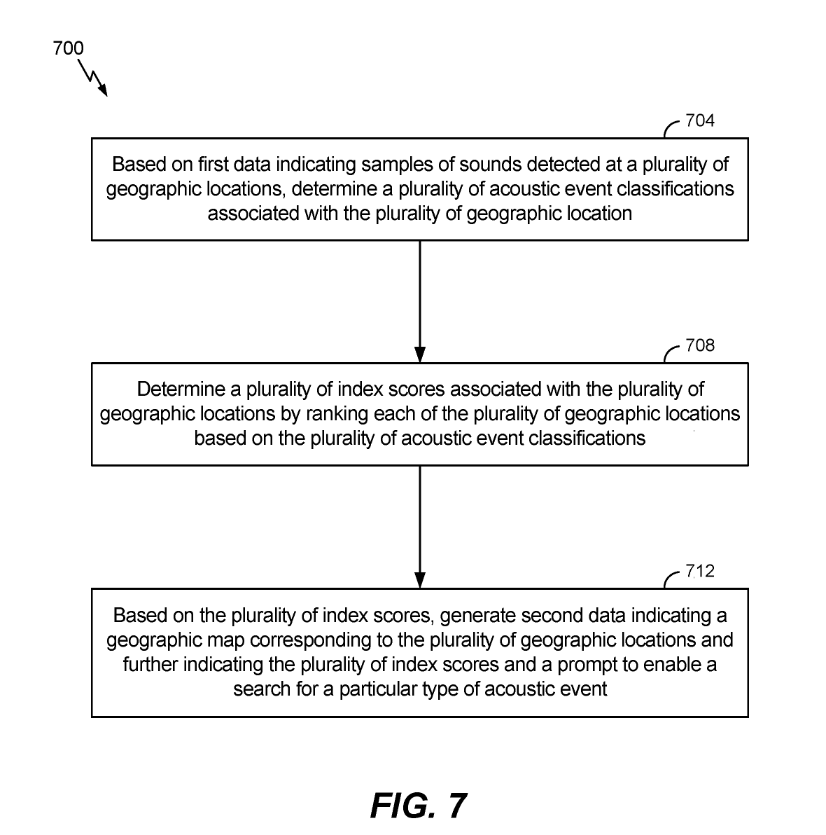

In a particular example, the classifier circuit 128 is configured to perform a first evaluation of the samples 116 based on the first time scale 521, a second evaluation of the samples 116 based on the second time scale 522, a third evaluation of the samples 116 based on the third time scale 523, and a fourth evaluation of the samples 116 based on the fourth time scale 524. Examples of operations using different time scales are described further with reference to FIGS. 6 and 7.

Referring to FIG. 6, an example of a classification process is depicted and generally designated 600. In a particular example, the classification process 600 is performed by the electronic device 108 of FIG. 1, such as using the classifier circuit 128 to determine the plurality of acoustic event classifications 142.

The classification process 600 includes generating a plurality of posteriorgrams, at 602. For example, the plurality of posteriorgrams may include a posteriorgram 504 and a posteriorgram 508. The plurality of posteriorgrams may include M posteriorgrams, where M is a positive integer greater than one. The plurality of posteriorgrams may be generated based on samples, such as the samples 116, the augmented samples 516, other samples, or a combination thereof.

Each posteriorgram of the plurality of posteriorgrams may indicate probabilities that samples associated with a particular time scale correspond to particular classes of acoustic events, such as the classes 147 of FIG. 1. For example, each posteriorgram of the plurality of posteriorgrams may include a matrix of values, where each row of the matrix is associated with a respective sample and where each column of the matrix is associated with a particular class. In this example, each value of the matrix may indicate a probability that the corresponding sample (based on the row containing the value) corresponds to the corresponding class (based on the column containing the value). In a particular example, each probability of the matrix may be determined by matching the samples 116 to the reference sound information 138. In this example, each probability may indicate how closely a particular sample of the samples 116 matches a corresponding reference sample of the reference sound information 138.

The plurality of posteriorgrams may be generated for the plurality of time scales 520. To illustrate, the posteriorgram 504 may correspond to one of the time scales 521-524, and the posteriorgram 508 may correspond to another of the time scales 521-524.

The classification process 600 further includes generating a combined posteriorgram 622, at 620. For example, the plurality of posteriorgrams may be combined (e.g., appended) to generate the combined posteriorgram 622.

The classification process 600 further includes applying one or more thresholds to the combined posteriorgram 622 and summing the thresholded posterior probabilities to generate results 632, at 630. For example, thresholding may include identifying one or more posterior probabilities that fail to satisfy a threshold (e.g., a confidence level). For example, if a posterior probability has a probability of 50 percent or less, then the posterior probability may be discarded. After thresholding one or more posterior probabilities, the remaining posterior probabilities for each class may be summed to generate the results 632. The results 632 may indicate a sum of posterior probabilities for each class of the classes 147 of FIG. 1. In an alternate example, thresholding may be performed prior to combining the posterior probabilities to generate the combined posteriorgram 622.

The classification process 600 further includes selecting a class corresponding to the largest sum indicated by the results 632, at 640. The class may correspond to one of the plurality of acoustic event classifications 142.

The example of FIG. 6 illustrates that analysis of the samples 116 may be performed using different time scales to generate posterior probabilities. If one or more of the posterior probabilities fail to satisfy a threshold, the one or more posterior probabilities may be discarded (e.g., thresholded). In some cases, use of the multiple time scales may improve accuracy of acoustic event classification, such as by enabling detection of a short or infrequent acoustic event. As a result, use of the multiple time scales may address certain technical problems, such as difficulty in classifying acoustic events. For example, use of one or more aspects described with reference to FIG. 6 may reduce or avoid reliance on “manual” classification of acoustic events.

Referring to FIG. 7, an illustrative example of a method of generating data indicating geographic locations and index scores associated with the geographic locations is depicted and generally designated 700. The method 700 may be performed by an electronic device, such as the electronic device 108 of FIG. 1, as an illustrative example. Depending on the particular implementation, one or more operations of the method 700 may be performed by a mobile device, a base station, a server, or another electronic device.

The method 700 includes determining, based on first data indicating samples of sounds detected at a plurality of geographic locations, a plurality of acoustic event classifications associated with the plurality of geographic locations, at 704. For example, the classifier circuit 128 is configured to identify the plurality of acoustic event classifications 142 based on the first data 104. The first data 104 includes the samples 116 associated with the plurality of geographic locations 118.

The method 700 further includes determining a plurality of index scores associated with the plurality of geographic locations by ranking each of the plurality of geographic locations based on the plurality of acoustic event classifications, at 708. For example, the ranking circuit 132 is configured to determine the plurality of index scores 146 associated with the plurality of geographic locations 118 by ranking each of the plurality of geographic locations 118 based on the plurality of acoustic event classifications 142.

The method 700 further includes generating, based on the plurality of index scores, second data indicating a geographic map corresponding to the plurality of geographic locations, at 712. The second data further indicates the plurality of index scores and a prompt to enable a search for a particular type of acoustic event. To illustrate, the data generator circuit 136 is configured to generate the second data 112. The second data 112 indicates the geographic map 144, the plurality of index scores 146, and the prompt 148.

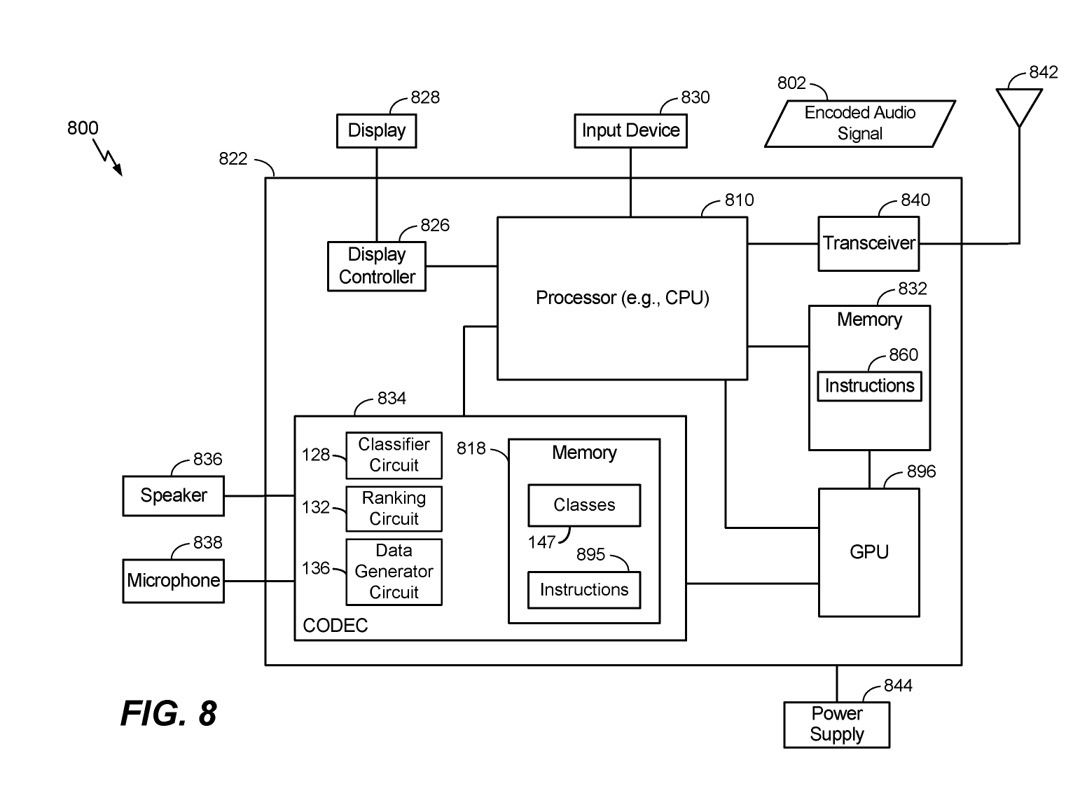

Referring to FIG. 8, a block diagram of a particular illustrative example of an electronic device is depicted and generally designated 800. In an illustrative example, the electronic device 800 corresponds to a mobile device (e.g., a cellular phone). Alternatively or in addition, one or more aspects of the electronic device 800 may be implemented within a computer (e.g., a server, a laptop computer, a tablet computer, or a desktop computer), an access point, a base station, a wearable electronic device (e.g., a personal camera, a head-mounted display, or a watch), a vehicle control system or console, an autonomous vehicle (e.g., a robotic car or a drone), a home appliance, a set top box, an entertainment device, a navigation device, a personal digital assistant (PDA), a television, a monitor, a tuner, a radio (e.g., a satellite radio), a music player (e.g., a digital music player or a portable music player), a video player (e.g., a digital video player, such as a digital video disc (DVD) player or a portable digital video player), a robot, a healthcare device, another electronic device, or a combination thereof.

The electronic device 800 includes one or more processors, such as a processor 810 and a graphics processing unit (GPU) 896. The processor 810 may include a central processing unit (CPU), a DSP, another processing device, or a combination thereof.

The electronic device 800 may further include one or more memories, such as a memory 832. The memory 832 may be coupled to the processor 810, to the GPU 896, or to both. The memory 832 may include random access memory (RAM), magnetoresistive random access memory (MRAM), flash memory, read-only memory (ROM), programmable read-only memory (PROM), erasable programmable read-only memory (EPROM), electrically erasable programmable read-only memory (EEPROM), one or more registers, a hard disk, a removable disk, a compact disc read-only memory (CD-ROM), another memory device, or a combination thereof.

The memory 832 may store instructions 860. The instructions 860 may be executable by the processor 810, by the GPU 896, or by both. The instructions 860 may be executable to perform, initiate, or control one or more operations described with reference to the method 700 of FIG. 7.

A CODEC 834 can also be coupled to the processor 810. The CODEC 834 may be coupled to one or more microphones, such as a microphone 838. In the example of FIG. 8, the CODEC 834 includes the classifier circuit 128, the ranking circuit 132, and the data generator circuit 136. In other implementations, one or more of the classifier circuit 128, the ranking circuit 132, and the data generator circuit 136 may be external to the CODEC 834.

The CODEC 834 may include a memory 818. The memory 818 may store instructions 895 executable by the CODEC 834. FIG. 8 also depicts that the memory 818 may store indications of the classes 147 of acoustic events.

FIG. 8 also shows a display controller 826 that is coupled to the processor 810 and to a display 828. A speaker 836 may be coupled to the CODEC 834.

The electronic device 800 may further include a transceiver 840 coupled to an antenna 842. The transceiver 840 may be configured to transmit an encoded audio signal 802 that includes the second data 112 of FIG. 1. Alternatively or in addition, the transceiver 840 may be configured to receive an encoded audio signal that includes the second data 112, to transmit an encoded audio signal representing the first data 104, or to receive an encoded audio signal representing the first data 104.

In a particular example, the processor 810, the GPU 896, the memory 832, the display controller 826, the CODEC 834, and the transceiver 840 are included in a system-on-chip (SoC) device 822. Further, an input device 830 and a power supply 844 may be coupled to the SoC device 822. Moreover, in a particular example, as illustrated in FIG. 8, the display 828, the input device 830, the speaker 836, the microphone 838, the antenna 842, and the power supply 844 are external to the SoC device 822. However, each of the display 828, the input device 830, the speaker 836, the microphone 838, the antenna 842, and the power supply 844 can be coupled to a component of the SoC device 822, such as to an interface or to a controller.

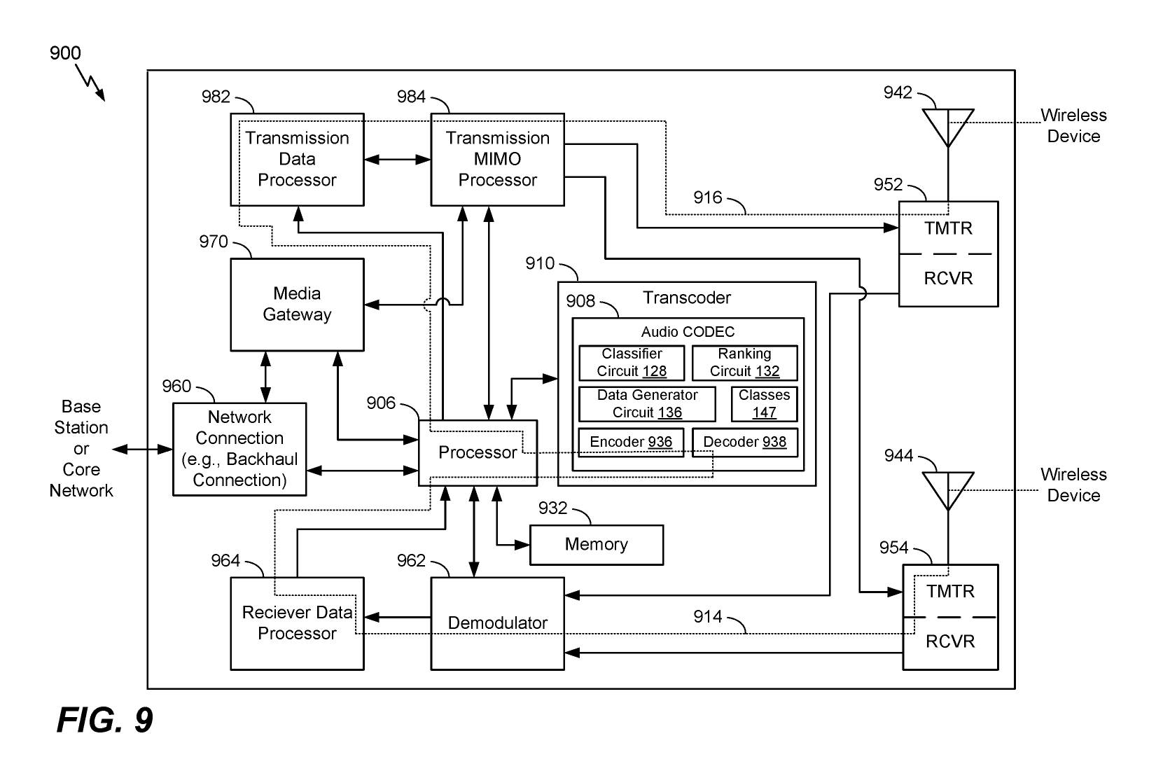

Referring to FIG. 9, a block diagram of a particular illustrative example of a base station 900 is depicted. In various implementations, the base station 900 may have more components or fewer components than illustrated in FIG. 9. In an illustrative example, the base station 900 may include the electronic device 108 of FIG. 1. In an illustrative example, the base station 900 may operate according to the method 700 of FIG. 7.

The base station 900 may be part of a wireless communication system. The wireless communication system may include multiple base stations and multiple wireless devices. The wireless communication system may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1×, Evolution-Data Optimized (EVDO), Time Division Synchronous CDMA (TD-SCDMA), or some other version of CDMA.

The wireless devices may also be referred to as user equipment (UE), a mobile station, a terminal, an access terminal, a subscriber unit, a station, etc. The wireless devices may include a cellular phone, a smartphone, a tablet, a wireless modem, a personal digital assistant (PDA), a handheld device, a laptop computer, a smartbook, a netbook, a tablet, a cordless phone, a wireless local loop (WLL) station, a Bluetooth device, etc. The wireless devices may include or correspond to the electronic device 800 of FIG. 8.

Various functions may be performed by one or more components of the base station 900 (and/or in other components not shown), such as sending and receiving messages and data (e.g., audio data). In a particular example, the base station 900 includes a processor 906 (e.g., a CPU). The base station 900 may include a transcoder 910. The transcoder 910 may include an audio CODEC 908. For example, the transcoder 910 may include one or more components (e.g., circuitry) configured to perform operations of the audio CODEC 908. As another example, the transcoder 910 may be configured to execute one or more computer-readable instructions to perform the operations of the audio CODEC 908. Although the audio CODEC 908 is illustrated as a component of the transcoder 910, in other examples one or more components of the audio CODEC 908 may be included in the processor 906, another processing component, or a combination thereof. For example, a decoder 938 (e.g., a vocoder decoder) may be included in a receiver data processor 964. As another example, an encoder 936 (e.g., a vocoder encoder) may be included in a transmission data processor 982.

The transcoder 910 may be configured to transcode messages and data between two or more networks. The transcoder 910 may be configured to convert message and audio data from a first format (e.g., a digital format) to a second format. To illustrate, the decoder 938 may decode encoded signals having a first format and the encoder 936 may encode the decoded signals into encoded signals having a second format. Additionally or alternatively, the transcoder 910 may be configured to perform data rate adaptation. For example, the transcoder 910 may downconvert a data rate or upconvert the data rate without changing a format of the audio data. To illustrate, the transcoder 910 may downconvert 64 kilobits per second (kbps) signals into 16 kbps signals.

The audio CODEC 908 may include the encoder 936 and the decoder 938. The encoder 936 may include an encoder selector, a speech encoder, and a non-speech encoder. The decoder 938 may include a decoder selector, a speech decoder, and a non-speech decoder. In the example of FIG. 9, the audio CODEC 908 includes the classifier circuit 128, the ranking circuit 132, and the data generator circuit 136. In other implementations, one or more of the classifier circuit 128, the ranking circuit 132, and the data generator circuit 136 may be external to the audio CODEC 908. The audio CODEC 908 may also store indications of the classes 147 of acoustic events.

The base station 900 may include a memory 932. The memory 932, such as a computer-readable storage device, may include instructions. The instructions may include one or more instructions that are executable by the processor 906, the transcoder 910, or a combination thereof, to perform one or more operations of the method 700 of FIG. 7. The base station 900 may include multiple transmitters and receivers (e.g., transceivers), such as a first transceiver 952 and a second transceiver 954, coupled to an array of antennas. The array of antennas may include a first antenna 942 and a second antenna 944. The array of antennas may be configured to wirelessly communicate with one or more wireless devices, such as the electronic device 800 of FIG. 8. For example, the second antenna 944 may receive a data stream 914 (e.g., a bit stream) from a wireless device. The data stream 914 may include messages, data (e.g., encoded speech data), or a combination thereof.

The base station 900 may include a network connection 960, such as backhaul connection. The network connection 960 may be configured to communicate with a core network or one or more base stations of the wireless communication network. For example, the base station 900 may receive a second data stream (e.g., messages or audio data) from a core network via the network connection 960. The base station 900 may process the second data stream to generate messages or audio data and provide the messages or the audio data to one or more wireless device via one or more antennas of the array of antennas or to another base station via the network connection 960. In a particular implementation, the network connection 960 may be a wide area network (WAN) connection, as an illustrative, non-limiting example. In some implementations, the core network may include or correspond to a Public Switched Telephone Network (PSTN), a packet backbone network, or both.

The base station 900 may include a media gateway 970 that is coupled to the network connection 960 and the processor 906. The media gateway 970 may be configured to convert between media streams of different telecommunications technologies. For example, the media gateway 970 may convert between different transmission protocols, different coding schemes, or both. To illustrate, the media gateway 970 may convert from PCM signals to Real-Time Transport Protocol (RTP) signals, as an illustrative, non-limiting example. The media gateway 970 may convert data between packet switched networks (e.g., a Voice Over Internet Protocol (VoIP) network, an IP Multimedia Subsystem (IMS), a fourth generation (4G) wireless network, such as LTE, WiMax, and UMB, etc.), circuit switched networks (e.g., a PSTN), and hybrid networks (e.g., a second generation (2G) wireless network, such as GSM, GPRS, and EDGE, a third generation (3G) wireless network, such as WCDMA, EV-DO, and HSPA, etc.).

Additionally, the media gateway 970 may include a transcoder, such as the transcoder 910, and may be configured to transcode data when codecs are incompatible. For example, the media gateway 970 may transcode between an Adaptive Multi-Rate (AMR) codec and a G.711 codec, as an illustrative, non-limiting example. The media gateway 970 may include a router and a plurality of physical interfaces. In some implementations, the media gateway 970 may also include a controller (not shown). In a particular implementation, the media gateway controller may be external to the media gateway 970 or to the base station 900. The media gateway controller may control and coordinate operations of multiple media gateways. The media gateway 970 may receive control signals from the media gateway controller and may function to bridge between different transmission technologies and may add service to end-user capabilities and connections.

The base station 900 may include a demodulator 962 that is coupled to the transceivers 952, 954, the receiver data processor 964, and the processor 906. The receiver data processor 964 may be coupled to the processor 906. The demodulator 962 may be configured to demodulate modulated signals received from the transceivers 952, 954 and to provide demodulated data to the receiver data processor 964. The receiver data processor 964 may be configured to extract a message or audio data from the demodulated data and send the message or the audio data to the processor 906.

The base station 900 may include a transmission data processor 982 and a transmission multiple input-multiple output (MIMO) processor 984. The transmission data processor 982 may be coupled to the processor 906 and the transmission MIMO processor 984. The transmission MIMO processor 984 may be coupled to the transceivers 952, 954 and the processor 906. In some implementations, the transmission MIMO processor 984 may be coupled to the media gateway 970. The transmission data processor 982 may be configured to receive the messages or the audio data from the processor 906 and to code the messages or the audio data based on a coding scheme, such as CDMA or orthogonal frequency-division multiplexing (OFDM), as an illustrative, non-limiting examples. The transmission data processor 982 may provide the coded data to the transmission MIMO processor 984.

The coded data may be multiplexed with other data, such as pilot data, using CDMA or OFDM techniques to generate multiplexed data. The multiplexed data may then be modulated (i.e., symbol mapped) by the transmission data processor 982 based on a particular modulation scheme (e.g., binary phase-shift keying (BPSK), quadrature phase-shift keying (QSPK), M-ary phase-shift keying (M-PSK), M-ary quadrature amplitude modulation (M-QAM), etc.) to generate modulation symbols. In a particular implementation, the coded data and other data may be modulated using different modulation schemes. The data rate, coding, and modulation for each data stream may be determined by instructions executed by processor 906.

The transmission MIMO processor 984 may be configured to receive the modulation symbols from the transmission data processor 982 and may further process the modulation symbols and may perform beamforming on the data. For example, the transmission MIMO processor 984 may apply beamforming weights to the modulation symbols. The beamforming weights may correspond to one or more antennas of the array of antennas from which the modulation symbols are transmitted.

During operation, the second antenna 944 of the base station 900 may receive a data stream 914. The second transceiver 954 may receive the data stream 914 from the second antenna 944 and may provide the data stream 914 to the demodulator 962. The demodulator 962 may demodulate modulated signals of the data stream 914 and provide demodulated data to the receiver data processor 964. The receiver data processor 964 may extract audio data from the demodulated data and provide the extracted audio data to the processor 906.

The processor 906 may provide the audio data to the transcoder 910 for transcoding. The decoder 938 of the transcoder 910 may decode the audio data from a first format into decoded audio data and the encoder 936 may encode the decoded audio data into a second format. In some implementations, the encoder 936 may encode the audio data using a higher data rate (e.g., upconvert) or a lower data rate (e.g., downconvert) than received from the wireless device. In other implementations the audio data may not be transcoded. Although transcoding (e.g., decoding and encoding) is illustrated as being performed by a transcoder 910, the transcoding operations (e.g., decoding and encoding) may be performed by multiple components of the base station 900. For example, decoding may be performed by the receiver data processor 964 and encoding may be performed by the transmission data processor 982. In other implementations, the processor 906 may provide the audio data to the media gateway 970 for conversion to another transmission protocol, coding scheme, or both. The media gateway 970 may provide the converted data to another base station or core network via the network connection 960.

The decoder 938 and the encoder 936 may select a corresponding decoder (e.g., a speech decoder or a non-speech decoder) and a corresponding encoder to transcode (e.g., decode and encode) the frame. The decoder 938 and the encoder 936 may determine, on a frame-by-frame basis, whether each received frame of the data stream 914 corresponds to a narrowband frame or a wideband frame and may select a corresponding decoding output mode (e.g., a narrowband output mode or a wideband output mode) and a corresponding encoding output mode to transcode (e.g., decode and encode) the frame. Encoded audio data generated at the encoder 936, such as transcoded data, may be provided to the transmission data processor 982 or the network connection 960 via the processor 906.

The transcoded audio data from the transcoder 910 may be provided to the transmission data processor 982 for coding according to a modulation scheme, such as OFDM, to generate the modulation symbols. The transmission data processor 982 may provide the modulation symbols to the transmission MIMO processor 984 for further processing and beamforming. The transmission MIMO processor 984 may apply beamforming weights and may provide the modulation symbols to one or more antennas of the array of antennas, such as the first antenna 942 via the first transceiver 952. Thus, the base station 900 may provide a transcoded data stream 916, that corresponds to the data stream 914 received from the wireless device, to another wireless device. The transcoded data stream 916 may have a different encoding format, data rate, or both, than the data stream 914. In other implementations, the transcoded data stream 916 may be provided to the network connection 960 for transmission to another base station or a core network.

In conjunction with the described embodiments, an apparatus includes means (e.g., the classifier circuit 128) for determining, based on first data (e.g., the first data 104) indicating samples (e.g., the samples 116) of sounds detected at a plurality of geographic locations (e.g., the plurality of geographic locations 118), a plurality of acoustic event classifications (e.g., the plurality of acoustic event classifications 142) associated with the plurality of geographic locations. The apparatus further includes means (e.g., the ranking circuit 132) for ranking each of the plurality of geographic locations based on the plurality of acoustic event classifications to determine a plurality of index scores (e.g., the plurality of index scores 146) associated with the plurality of geographic locations. The apparatus further includes means (e.g., the data generator circuit 136) for generating, based on the plurality of index scores, second data (e.g., the second data 112) indicating a geographic map (e.g., the geographic map 144) corresponding to the plurality of geographic locations. The second data further indicates the plurality of index scores and a prompt (e.g., the prompt 148) to enable a search for a particular type of acoustic event.

In conjunction with the described embodiments, a computer-readable medium (e.g., the memory 818, the memory 832, or the memory 932) stores instructions (e.g., the instructions 860 or the instructions 895) executable by a processor (e.g., the processor 810, the GPU 896, a processor of the CODEC 834, the processor 906, or the transcoder 910) to cause the processor to perform operations. The operations include determining based on first data (e.g., the first data 104) indicating samples (e.g., the samples 116) of sounds detected at a plurality of geographic locations (e.g., the plurality of geographic locations 118), a plurality of acoustic event classifications (e.g., the plurality of acoustic event classifications 142) associated with the plurality of geographic locations. The operations further include determining a plurality of index scores (e.g., the plurality of index scores 146) associated with the plurality of geographic locations by ranking each of the plurality of geographic locations based on the plurality of acoustic event classifications. The operations further include generating, based on the plurality of index scores, second data (e.g., the second data 112) indicating a geographic map (e.g., the geographic map 144) corresponding to the plurality of geographic locations. The second data further indicates the plurality of index scores and a prompt (e.g., the prompt 148) to enable a search for a particular type of acoustic event.

As used herein, “coupled” may include communicatively coupled, electrically coupled, magnetically coupled, physically coupled, optically coupled, and combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc.

As used herein, “generating,” “calculating,” “using,” “selecting,” “accessing,” and “determining” may be used interchangeably. For example, “generating,” “calculating,” or “determining” a value, a characteristic, a parameter, or a signal may refer to actively generating, calculating, or determining a value, a characteristic, a parameter, or a signal or may refer to using, selecting, or accessing a value, a characteristic, a parameter, or a signal that is already generated, such as by a component or a device.

The foregoing disclosed devices and functionalities may be designed and represented using computer files (e.g. RTL, GDSII, GERBER, etc.). The computer files may be stored on computer-readable media. Some or all such files may be provided to fabrication handlers who fabricate devices based on such files. Resulting products include wafers that are then cut into die and packaged into integrated circuits (or “chips”). The integrated circuits are then employed in electronic devices, such as the electronic device 800 of FIG. 8.

Although certain examples have been described separately for convenience, it is noted that aspects of such examples may be suitably combined without departing from the scope of the disclosure. For example, the electronic device 108 of FIG. 1 may be configured to operate based on one or more aspects described with reference to FIGS. 2-9. Those of skill in the art will recognize other such modifications that are within the scope of the disclosure.

The various illustrative logical blocks, configurations, modules, circuits, and algorithm steps described in connection with the examples disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

One or more operations of a method or algorithm described herein may be embodied directly in hardware, in a software module executed by a processor, or in a combination of the two. For example, one or more operations of the method 700 of FIG. 7 may be initiated, controlled, or performed by a field-programmable gate array (FPGA) device, an application-specific integrated circuit (ASIC), a processing unit such as a central processing unit (CPU), a digital signal processor (DSP), a controller, another hardware device, a firmware device, or a combination thereof. A software module may reside in random access memory (RAM), magnetoresistive random access memory (MRAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transitory storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed examples is provided to enable a person skilled in the art to make or use the disclosed examples. Various modifications to these examples will readily apparent to those skilled in the art, and the principles defined herein may be applied to other examples without departing from the scope of the disclosure. Thus, the present disclosure is not intended to be limited to the examples shown herein but is to be accorded the widest scope possible consistent with the principles and novel features as defined by the following claims.

What is claimed is:

1. An electronic device comprising:
a classifier circuit configured to determine, based on first data indicating samples of sounds detected at a plurality of geographic locations, a plurality of acoustic event classifications associated with the plurality of geographic locations;
a ranking circuit configured to determine a plurality of index scores associated with the plurality of geographic locations by ranking each of the plurality of geographic locations based on the plurality of acoustic event classifications; and
a data generator circuit configured to generate, based on the plurality of index scores, second data indicating a geographic map corresponding to the plurality of geographic locations and further indicating the plurality of index scores and a prompt to enable a search for a particular type of acoustic event.

2. The electronic device of claim 1, wherein the plurality of index scores includes one or more of a neighborhood score, a livability score, a safety rating, a health score, or a leisure score.

3. The electronic device of claim 1, wherein the plurality of acoustic event classifications include one or more of a traffic classification, a train classification, an aircraft classification, a motorcycle classification, a siren classification, an animal classification, a child classification, a music classification, or a nightlife classification.

4. The electronic device of claim 1, wherein the first data further indicates a plurality of sound pressure level (SPL) values associated with the plurality of geographic locations, and wherein the classifier circuit is further configured to determine the plurality of acoustic event classifications further based on the plurality of SPL values.

5. The electronic device of claim 1, wherein the first data further indicates timestamp information associated with the samples, and wherein the classifier circuit is further configured to determine the plurality of acoustic event classifications further based on the timestamp information.

6. The electronic device of claim 1, wherein the classifier circuit is further configured to determine the plurality of acoustic event classifications by comparing the samples to reference sound information.

7. The electronic device of claim 1, further comprising:
an antenna; and
a transceiver coupled to the antenna and configured to transmit an encoded audio signal that includes the second data.

8. The electronic device of claim 7, wherein classifier circuit, the ranking circuit, the data generator circuit, the antenna, and the transceiver are integrated into a mobile device.

9. A method of generating data indicating geographic locations and index scores associated with the geographic locations, the method comprising:
based on first data indicating samples of sounds detected at a plurality of geographic locations, determining a plurality of acoustic event classifications associated with the plurality of geographic locations;
determining a plurality of index scores associated with the plurality of geographic locations by ranking each of the plurality of geographic locations based on the plurality of acoustic event classifications; and
based on the plurality of index scores, generating second data indicating a geographic map corresponding to the plurality of geographic locations and further indicating the plurality of index scores and a prompt to enable a search for a particular type of acoustic event.

10. The method of claim 9, wherein the plurality of index scores includes one or more of a neighborhood score, a livability score, a safety rating, a health score, or a leisure score.

11. The method of claim 9, wherein the plurality of acoustic event classifications include one or more of a traffic classification, a train classification, an aircraft classification, a motorcycle classification, a siren classification, an animal classification, a child classification, a music classification, or a nightlife classification.

12. The method of claim 9, wherein the first data further indicates a plurality of sound pressure level (SPL) values associated with the plurality of geographic locations, and wherein the plurality of index scores is determined further based on the plurality of SPL values.

13. The method of claim 9, wherein the first data further indicates timestamp information associated with the samples, and wherein the plurality of index scores is determined further based on the timestamp information.

14. The method of claim 9, wherein determining the plurality of acoustic event classifications includes comparing the samples to reference sound information.

15. The method of claim 9, wherein determining the plurality of acoustic event classifications, determining the plurality of index scores, and generating the second data are performed at a server.

16. The method of claim 9, wherein determining the plurality of acoustic event classifications, determining the plurality of index scores, and generating the second data are performed at a mobile device.

17. The method of claim 9, wherein determining the plurality of acoustic event classifications, determining the plurality of index scores, and generating the second data are performed at a base station.

18. An apparatus comprising:
means for determining, based on first data indicating samples of sounds detected at a plurality of geographic locations, a plurality of acoustic event classifications associated with the plurality of geographic locations;
means for ranking each of the plurality of geographic locations based on the plurality of acoustic event classifications to determine a plurality of index scores associated with the plurality of geographic locations; and
means for generating, based on the plurality of index scores, second data indicating a geographic map corresponding to the plurality of geographic locations and further indicating the plurality of index scores and a prompt to enable a search for a particular type of acoustic event.

19. The apparatus of claim 18, wherein the plurality of index scores includes one or more of a neighborhood score, a livability score, a safety rating, a health score, or a leisure score.

20. The apparatus of claim 18, wherein the plurality of acoustic event classifications include one or more of a traffic classification, a train classification, an aircraft classification, a motorcycle classification, a siren classification, an animal classification, a child classification, a music classification, or a nightlife classification.

21. The apparatus of claim 18, wherein the first data further indicates a plurality of sound pressure level (SPL) values associated with the plurality of geographic locations, and wherein the means for ranking is configured to determine the plurality of acoustic event classifications further based on the plurality of SPL values.

22. The apparatus of claim 18, wherein the first data further indicates timestamp information associated with the samples, and wherein the means for ranking is configured to determine the plurality of acoustic event classifications further based on the timestamp information.

23. The apparatus of claim 18, wherein the means for determining is configured to determine the plurality of acoustic event classifications by comparing the samples to reference sound information.

24. The apparatus of claim 18, wherein the means for determining, the means for ranking, and the means for generating are integrated into a mobile device.

25. A computer-readable medium storing instructions executable by a processor to perform operations comprising:
based on first data indicating samples of sounds detected at a plurality of geographic locations, determining a plurality of acoustic event classifications associated with the plurality of geographic locations;
determining a plurality of index scores associated with the plurality of geographic locations by ranking each of the plurality of geographic locations based on the plurality of acoustic event classifications; and
based on the plurality of index scores, generating second data indicating a geographic map corresponding to the plurality of geographic locations and further indicating the plurality of index scores and a prompt to enable a search for a particular type of acoustic event.

26. The computer-readable medium of claim 25, wherein the plurality of index scores includes one or more of a neighborhood score, a livability score, a safety rating, a health score, or a leisure score.

27. The computer-readable medium of claim 25, wherein the plurality of acoustic event classifications include one or more of a traffic classification, a train classification, an aircraft classification, a motorcycle classification, a siren classification, an animal classification, a child classification, a music classification, or a nightlife classification.

28. The computer-readable medium of claim 25, wherein the first data further indicates a plurality of sound pressure level (SPL) values associated with the plurality of geographic locations, and wherein the plurality of acoustic event classifications are determined further based on the plurality of SPL values.

29. The computer-readable medium of claim 25, wherein the first data further indicates timestamp information associated with the samples, and wherein the plurality of acoustic event classifications are determined further based on the timestamp information.

30. The computer-readable medium of claim 25, wherein the plurality of acoustic event classifications are determined by comparing the samples to reference sound information.
